(19) United States
(12) Patent Application Publication
(10) Pub. No.: US 2025/0296787 A1
(43) Pub. Date: Sep. 25, 2025

(54) PNEUMATIC CIRCUIT FOR CONVEYING APPARATUS AND CONTROL METHOD THEREFOR

(71) Applicant: YUSHIN PRECISION EQUIPMENT CO., LTD., Kyoto (JP)

(72) Inventor: Hiroki Kida, Minami-ku (JP)

(21) Appl. No.: 19/081,440

(22) Filed: Mar. 17, 2025

(30) Foreign Application Priority Data
Mar. 22, 2024 (JP) 2024-046334

(51) Int. Cl. B65G 47/91

(52) U.S. Cl. CPC B65G 47/91

(57) ABSTRACT

A control valve mechanism includes a three-port valve provided at a front conduit section of a conduit line and a two-port valve provided at a rear conduit section of the conduit line, the two-port valve is controlled to be in an opened state during the suctioning operation and to be in a closed state during the releasing operation. The three-port valve is controlled to be in a first state in which negative pressure generated by a vacuum generator is supplied to one or more suction pads during the suctioning operation, and to be in a second state in which the supply of the negative pressure generated by the vacuum generator is blocked form a negative pressure confining section arranged between the three-port valve and the two-port valve and to open the inside of the one or more suction pads to the atmosphere during the releasing operation.

### TECHNICAL FIELD

The present invention relates to a pneumatic circuit for conveying apparatus for controlling negative pressure supplying one or more suction pads provided at a conveyance head and a control method therefor.

### BACKGROUND FIELD

Japan Patent 4,653,984 discloses an apparatus for taking out one or more molded products including a pneumatic circuit for conveying apparatus which comprises one or more suction pads provided at a chuck (a conveyance head) to convey one or more molded products (one or more conveyed products), a conduit line arranged between one or more suction pads and a vacuum generator, a negative pressure controlling section arranged in the conduit line, and having a negative pressure maintaining valve (a control valve) arranged so as to supply negative pressure generated by the vacuum generator to the one or more suction pads when the conveyed products are suctioned by the one or more suction pads, to open the negative pressure inside of the conduit line to the atmosphere when the conveyed products are released from the one or more suction pads. The apparatus mentioned above creates vacuum pressure into the chuck when moving from a standby position to a take-out position and controls the negative pressure of the chuck so as to reach the suction pressure just at the time when the chuck reaches the take-out position. Therefore, there is an advantage that the consumption of pressured air can be reduced since the suction ON signal is outputted just a timing when the negative pressure in the chuck reaches the suction pressure when the chuck reaches the take-out position, in comparison with the conventional technology that negative pressure is generated in the chuck beforehand when the chuck returns to the standby position and the negative pressure in the chuck reaches the suction pressure when the chuck reaches the take-out position.

### RELATED ART DOCUMENT

### Patent Documents

Patent Document 1: Japanese Patent No. 4,653,984 (Mar. 16, 2011)

### SUMMARY OF INVENTION

### Technical Problem

When one or more conveyed products are released from one or more suction pads in a conventional apparatus, negative pressure inside of a conduit line is opened to the atmosphere by being in a state for opening both a negative pressure retention valve and a vacuum generator so that all negative pressure inside of the conduit line are opened. During a suctioning operation in a next suctioning operation, the inside of the conduit line is required to be in a state for storing negative pressure again. In the conventional way, a lot of energy consumption are caused since the inside of the conduit line is required to be in a state for negative pressure every time. The longer the conduit line, the greater the energy consumption is obtained as mentioned above.

The purpose of the present invention is to provide a pneumatic circuit for conveying apparatus that is able to reduce energy consumption by more efficiently utilizing negative pressure to be generated than that in a conventional technology.

### Solution to Problem

A pneumatic circuit for conveying apparatus of the present invention comprises one or more suction pads provided at a conveyance head to convey one or more conveyed products, a conduit line arranged between the one or more suction pads and a vacuum generator, and a control valve mechanism including two or more control valves arranged in the conduit line, supplying negative pressure generated by the vacuum generator to the one or more suction pads during a suctioning operation in which the one or more conveyed products are suctioned by the one or more suction pads, opening inside of the one or more suction pads to the atmosphere and forming a negative pressure confining section in which the negative pressure is confined in a rear conduit section of the conduit line that is located closer to the vacuum generator than a front conduit section of the conduit line during a releasing operation in which the one or more conveyed products are released from the one or more suction pads, the two or more control valves being arranged to use both the negative pressure in the negative pressure confining section and the negative pressure generated by the vacuum generator when suctioning in a next conveying operation.

According to the present invention, a part of negative pressure to be generated during a suctioning operation is stored in a negative pressure confining section, and both negative pressure stored in the negative pressure confining section and negative pressure generated by the vacuum generator are used in combination in a next conveying operation, thereby the energy consumption can be more reduced than those in the conventional technologies, since the part of negative pressure is reused without wasting negative pressure to be generated.

A preferable control valve mechanism includes a three-port valve provided in the front conduit section and a two-port valve provided in the rear conduit section, the two-port valve is controlled to be in an open state during the suctioning operation and to be in a closed state during the releasing operation. In addition, the three-port valve of the control valve mechanism 6′ is controlled to be in a first state in which the negative pressure generated by the vacuum generator is supplied to the one or more suction pads during the suctioning operation, and to be in a second state in which the supply of the negative pressure generated by the vacuum generator is blocked to form the negative pressure confining section between the three-port valve and the two-port valve and to open the inside of the one or more suction pads to the atmosphere during the releasing operation, and the three-port valve is controlled to change from the second state to the first state during the suctioning operation in the next conveying operation, so that the negative pressure in the negative pressure confining section and the negative pressure generated by the vacuum generator are used in combination. According to the control valve mechanism mentioned above, a number of a port valve to be used can be minimized.

In addition, the control valve mechanism may include a first two-port valve and a second two-port valve provided at one end and the other end of the rear conduit section, respectively, and a third two-port valve provided in the front conduit section. In this case, the first two-port valve and the second two-port valve are respectively in an opened state during the suctioning operation and both the first two-port valve and the second two-port valve are in a closed state during the releasing operation to form the negative pressure confining section between the first two-port valve and the second two-port valve, and both the first two-port valve and the second two-port valve are in an opened state during the suctioning operation in the next conveying operation to supply the negative pressure in the negative pressure confining section and negative pressure supplied from the vacuum generator to the one or more suction pads. Therefore, the third two-port valve becomes a first state being able to supply the negative pressure generated by the vacuum generator to the one or more suction pads during the suctioning operation and becomes a second state to open the inside of the one or more suction pads to the atmosphere during the releasing operation, and is controlled so as to change from the second state to the first state before the suctioning operation in the next conveying operation is performed. According to the control valve mechanism mentioned above, the suctioning operation and the negative pressure confining operation can be performed by the presence of a third two-port valve without being affected by the time delay in the operations of a first two-port valve and a second two-port valve.

Note that a plurality of the suction pads are provided on the conveyance head, the conduit line may have a plurality of branch conduits each connected to the plurality of the suction pads respectively and a common conduit connecting the plurality of branch conduits with the vacuum generator. In this way, an additional three-port valve may be provided in at least one branch conduit among the plurality of branch conduits to open the inside of the at least one branch conduit to the atmosphere. In the case mentioned above, a plurality of suction pads can be individually released.

The pneumatic circuit for conveying apparatus of the present invention can be adopted to an apparatus for taking out a molded product.

The present invention can be also related to a method for controlling a pneumatic circuit for conveying apparatus. That is, the method subjected by the present invention is a method for controlling a circuit for pneumatic conveying apparatus that comprises one or more suction pads provided at a conveyance head to convey one or more conveyed products, a conduit line arranged between the one or more suction pads and a vacuum generator, and a control valve mechanism including two or more control valves arranged in a path of the conduit line, supplying negative pressure generated by the vacuum generator to the one or more suction pads during a suction operation in which the one or more conveyed products are suctioned by the one or more suction pads, and opening the inside of the one or more suction pads to the atmosphere during a releasing operation in which the one or more conveyed products are released from the one or more suction pads. The control valve mechanism controls the two or more control valves so as to form a negative pressure confining section in which the negative pressure is confined in a rear conduit section that is located closer to the vacuum generator than a front conduit section of the conduit line, and the control valve mechanism further controls the two or more control valves so as to supply both the negative pressure in the negative pressure confining section and the negative pressure generated by the vacuum generator to the one or more suction pads during the suctioning operation in the next conveying operation in the method of the present invention.

According to the method of the present invention, a part of negative pressure to be generated during a suctioning operation is stored in the negative pressure confining section, and both negative pressures stored in the negative pressure confining section and negative pressure generated by the vacuum generator are used in combination in a next conveying operation. Thereby the energy consumption can be more reduced than those in the conventional technologies, since a part of negative pressure is reused without wasting negative pressure to be generated.

### BRIEF DESCRIPTION OF DRAWINGS

FIG. 1 is a schematic diagram illustrating an example adapting a pneumatic circuit for conveying apparatus of the present embodiment to a suction pad provided at a take-out head for a molded product (a conveyance head for a molded product).

FIG. 2 is a diagram illustrating a configuration of a specific example of a pneumatic circuit for conveying apparatus used for the embodiment illustrated in FIG. 1.

FIG. 3 is a diagram illustrating the change over time of an operation of a pneumatic circuit for conveying apparatus illustrated in FIG. 2 and of changes of suction pressure of a suction pad in a first operation of taking out a product and a second operation of taking out a product.

FIG. 4A is a diagram illustrating the time axis aligned for the change of suction pressure in a conventional pneumatic circuit for conveying apparatus without a negative pressure confining section, and FIG. 4B is a diagram illustrating the time axis aligned for the change of suction pressure in a pneumatic circuit for conveying apparatus in the present embodiment with a negative pressure confining section.

FIG. 5 is a diagram illustrating a configuration of a specific example of a pneumatic circuit for conveying apparatus used for the second embodiment of the present invention.

FIG. 6 is a diagram illustrating the change over time of an operation of a pneumatic circuit for conveying apparatus and of the change of suction pressure of a suction pad in a first operation of taking out a product of the second embodiment and a second operation of taking out a product of the second embodiment.

FIG. 7 is a diagram illustrating for explaining a modified example.

### DESCRIPTION OF EMBODIMENTS

Hereinafter, an embodiment of a pneumatic circuit for conveying apparatus and a control method therefor of the present invention will be described in detail with reference to the drawings.

### First Embodiment

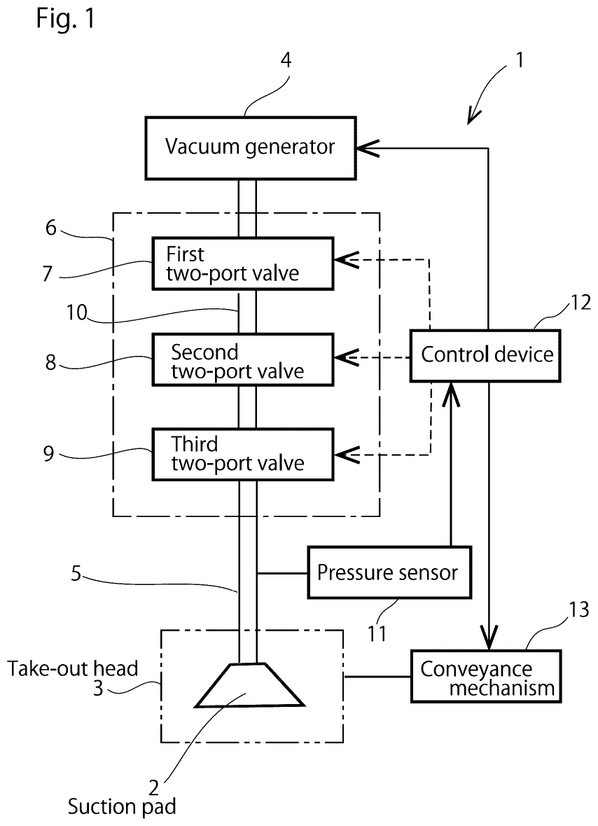

FIG. 1 is a schematic diagram illustrating an example adapting a pneumatic circuit for conveying apparatus 1 of the present embodiment to one or more suction pads 2 provided at a take-out head 3 of an apparatus for taking out a molded product. The pneumatic circuit for conveying apparatus 1 includes one or more suction pads 2 provided at the take-out head 3, the one or more suction pads 2 being used to take-out the one or more molded product as one or more conveyed products. The pneumatic circuit for conveying apparatus 1 further includes a conduit line 5 arranged between the one or more suction pads 2 and a vacuum generator 4, and a control valve mechanism 6 arranged in the conduit line 5. The control valve mechanism 6 includes a first two-port valve 7, a second two-port valve 8 and a third two-port valve 9, which will be respectively described later. A negative pressure confining section 10 is formed between the first two-port valve 7 and the second two-port valve 8. A pressure sensor 11 measuring negative pressure generated by the vacuum generator 4 is arranged in a part of the conduit line 5 positioned between the take-out head 3 and the third two-port valve 9. A control device 12 includes the function that applies a control command controlling opening and closing of the first two-port valve 7, the second two-port valve 8 and the third two-port valve 9 based on an output of the pressure sensor 11, the function that applies an operation command to the vacuum generator 4 based on a predetermined operation sequence and the function that applies a drive command to a conveying mechanism 13 of the apparatus for taking out a molded product to perform a movement of the head for taking out a molded product 3 based on a predetermined operation sequence.

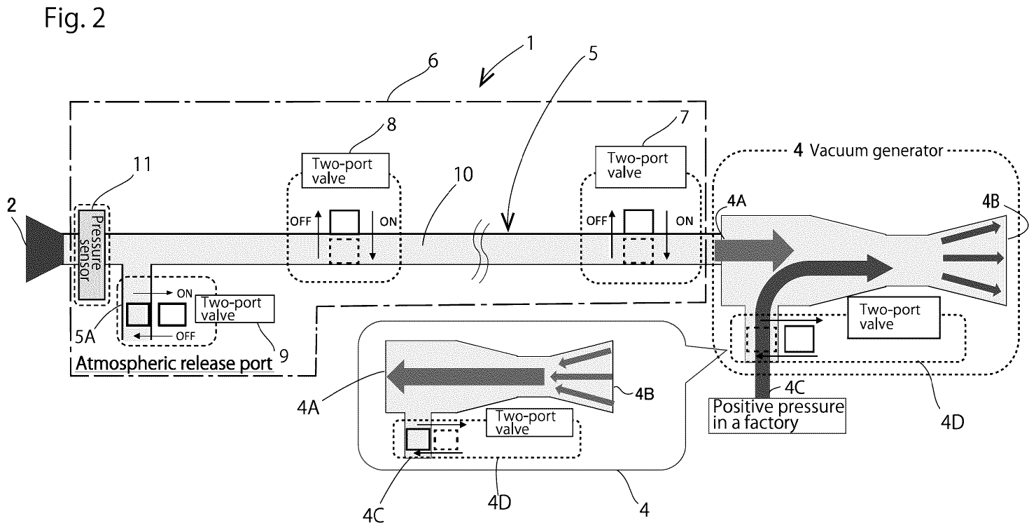

FIG. 2 is a diagram illustrating a configuration of a specific example of the pneumatic circuit for conveying apparatus 1 used for the embodiment illustrated in FIG. 1. As specifically illustrated in FIG. 2, the vacuum generator 4 includes an air intake 4A, a ventilation opening 4B, a supply inlet 4C incorporating positive pressure generated by a pump in a factory and a two-port valve 4D comprising a solenoid valve provided at the supply inlet 4C. The first two-port valve 7 is arranged at a conduit section close to the air intake 4A of the vacuum generator 4, and the second two-port valve 8 is arranged at a conduit section close to the suction pad 2. The third two-port valve 9 is arranged between the suction pad 2 and the second two-port valve 8. In the present specification, a conduit section positioned between the first two-port valve 7 and the second two-port valve 8 is called as a rear conduit section of the conduit line, and a conduit section positioned between the rear conduit section of the conduit line and the suction pad 2 is called as a front conduit section of the conduit line. In addition, in the present embodiment, the control valve mechanism 6 is configured by the first two-port valve 7 (a control valve), the second two-port valve 8 (a control valve) and the third two-port valve 9 (a control valve).

The two-port valves 4D, 7, 8 and 9 have two ports respectively, IN and OUT, and each two-port valve simply performs the action of closing or opening for one path. In the present embodiment, the first two-port valve 7 and the second two-port valve 8 are controlled so as to be in an opened state during a suctioning operation, and to be in a closed state during a releasing operation. In the present embodiment, the third two-port valve 9 is provided at a branch conduit line 5A connected to the front conduit section of the conduit line. The third two-port valve 9 is controlled so as to be in a first state for applying negative pressure generated by the vacuum generator 4 to the suction pad 2 during a suctioning operation, and to be in a second state for opening the inside of the suction pad 2 to the atmosphere during a releasing operation.

In a state illustrated in FIG. 2, each valve body of the two-port valves 4D, 7 and 8 has come out of the path and the path is in an opened state, since the valve body of the third two-port valve 9 closes an atmospheric release port of the branch conduit line 5A, the inside of the conduit line 5 is opened from the air intake 4A of the vacuum generator 4 to the atmosphere, thereby both the inside of the conduit line and the inside of the suction pad 2 become negative pressure. In the present specification, the state mentioned above is defined to “suppling negative pressure” generated by the vacuum generator 4.

A molded product (a conveyed product) is conveyed during a suctioning operation by the suction pad 2. Then, a state that the inside of the suction pad 2 is opened to the atmosphere by opening an atmospheric release port is formed (a second state) during a releasing operation for the molded product (the conveyed product) from the suction pad 2 at a predetermined conveyed position. Substantially simultaneously with the atmospheric releasing operation of the third two-port valve 9, the first two-port valve 7 and the second two-port valve 8 are closed, and the two-port valve 4D in the vacuum generator 4 is closed by the valve body to stop the supply of positive pressure into the vacuum generator 4. In case of being in a state that negative pressure is generated by the vacuum generator 4 (a first state), when the first two-port valve 7 and the second two-port valve 8 are closed, a state that negative pressure is reliably stored in the negative pressure confining section 10 is formed. As described in detail later, negative pressure stored in the negative pressure confining section 10 is used in combination with negative pressure generated by the vacuum generator 4 in a next conveying operation. That is, negative pressure stored in the negative pressure confining section 10 is added to negative pressure generated by the vacuum generator 4, and then those negative pressures in combination are supplied to the suction pad 2. Therefore, according to the present embodiment, a part of negative pressure to be generated during a suctioning operation is stored in the negative pressure confining section 10, and both negative pressure stored in the negative pressure confining section 10 and negative pressure generated by the vacuum generator 4 are used in combination in a next conveying operation, thereby the energy consumption can be more reduced than those in the conventional technologies, since a part of negative pressure is reused without wasting negative pressure to be generated.

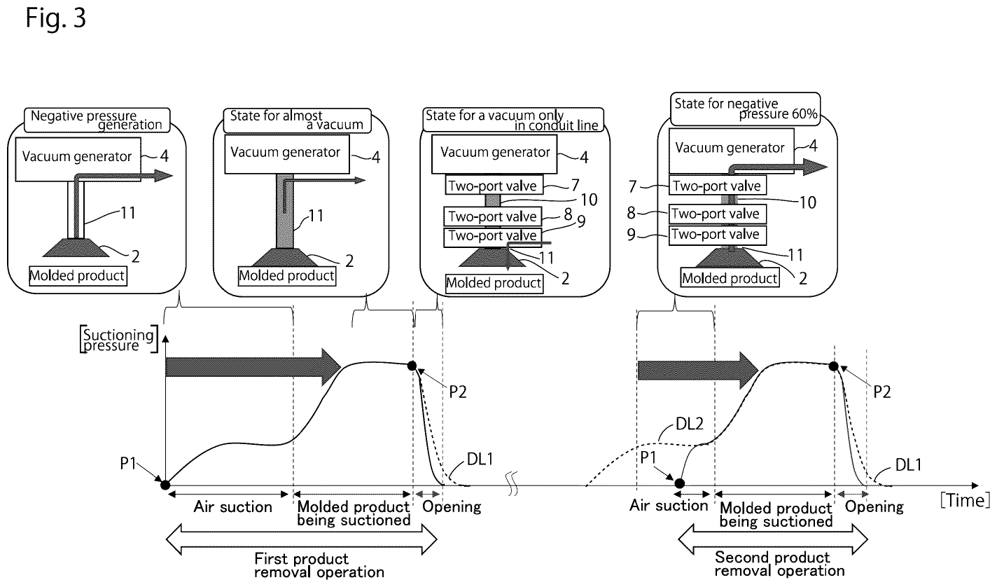

FIG. 3 illustrates the changes over time of an operation of a pneumatic circuit for conveying apparatus 1 illustrated in FIG. 2 and of changes of suction pressure of a suction pad 2 in a first operation for taking out a product and a second operation for taking out a product. Note that in FIG. 3, a suction pressure sensor 11 for measurement is arranged at a position close to the suction pad 2 for the purpose of ensuring data collection. First of all, the suction pad 2 is moved close to a molded product while performing air suction using the vacuum generator 4 for starting a suctioning operation (P1). When the suction pad 2 is in contact closely to the molded product, suctioning is started and suctioning (negative pressure pressure) is increased. The take-out head 3 moves to a release position (P2) while suctioning is saturated (while the inside the conduit line is almost a vacuum), and a release command is outputted when the movement is completed. When the release command is outputted, the first two-port valve 7 and the second two-port valve 8 are closed, then the path of the third two-port valve 9 becomes in an opened state since the operation of the vacuum generator 4 is stopped, thereby the inside of the suction pad 2 is opened to the atmosphere and the releasing of the molded product has been completed. Note that dotted lines DL1 illustrated during an open duration in the first operation for taking out a product and the second operation for taking out a product in FIG. 3 show the changes for suction pressure in case of 41 using a conventional pneumatic circuit for conveying apparatus without using the first two-port valve 7, the second two-port valve 8 and the third two-port valve 9.

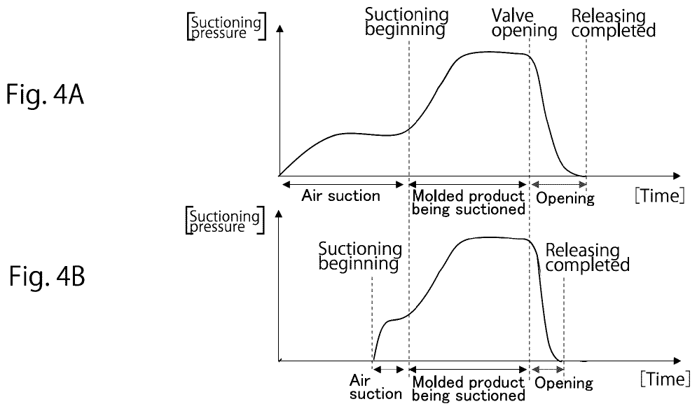

In case of the second operation for taking out a product as illustrated in FIG. 3, since the negative pressure in the negative pressure confining section 10 is also used with the negative pressure generated by the vacuum generator, the negative pressure rises in a short time. The dotted line DL2 at the time of suctioning operation beginning in the second operation for taking out a product as illustrated in FIG. 3 shows the changes for suction pressure in case of using a conventional pneumatic circuit for conveying apparatus without the negative pressure confining section 10. FIG. 4A illustrates the changes of suction pressure in case of using a conventional pneumatic circuit for conveying apparatus without a negative pressure confining section 10. FIG. 4B illustrates the changes of suction pressure in case of using the pneumatic circuit for conveying apparatus of the present embodiment with a negative pressure confining section 10. Both FIGS. 4A and 4B are illustrated as matching the timeline. As is clear from those figures explained above, according to the present embodiment, in the second operation for taking out a product and later therefrom, a time period by suctioning beginning and a time period by releasing completed are significantly shorter than before.

### Second Embodiment

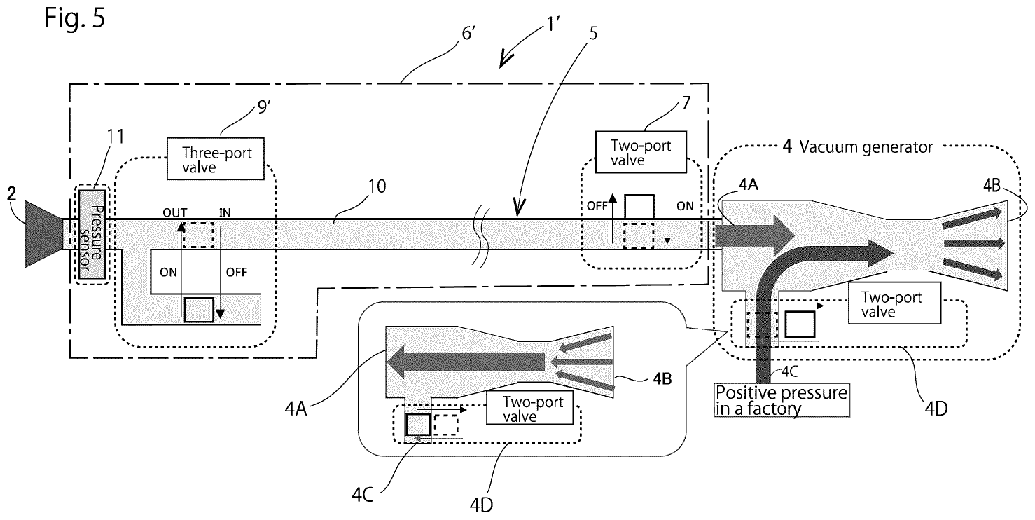

FIG. 5 is a diagram illustrating a configuration of a specific example of a pneumatic circuit for conveying apparatus 1′ used for the second embodiment of the present invention. The second embodiment differs from the first embodiment in that there is no second two-port valve 8 and that a three-port valve 9′ is used instead of the third two-port valve 9, as compared with the pneumatic circuit for conveying apparatus of the first embodiment illustrated in FIG. 2.

In the present embodiment, the control valve mechanism 6′ includes the three-port valve 9′ provided at a front conduit section of the conduit line and the two-port valve 7 provided at a rear conduit section of the conduit line. The two-port valve 7 is controlled as in an opened state during a suctioning operation and in a closed state during a releasing operation. Therefore, the three-port valve 9′ of the control valve mechanism 6′ is controlled as in a first state that supplies negative pressure generated by the vacuum generator 4 to the suction pad 2 during a suctioning operation, and in a second state that forms the negative pressure confining section 10 between the three-port valve 9′ and the two-port valve 7 by blocking negative pressure supply generated by the vacuum generator 4 and by opening the inside of the suction pad 2 to the atmosphere (through a branched route) during a releasing operation.

Furthermore, the three-port valve 9′ is controlled as using negative pressure the inside of the negative pressure confining section 10 and negative pressure generated by the vacuum generator 4 in combination by changing from the second state to the first state during a suctioning operation in a next conveying operation. According to the control valve mechanism 6′, a number of port valves to be used can be minimized.

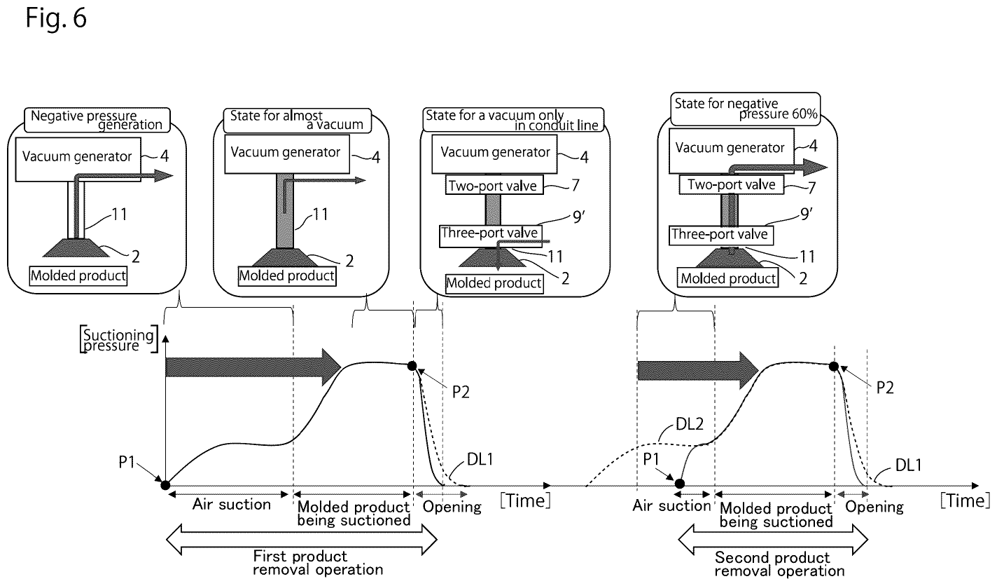

FIG. 6 is a diagram illustrating the change over time of an operation of a pneumatic circuit for conveying apparatus 1′ and of the change of suction pressure of a suction pad 2 in a first operation of taking out a product of the second embodiment and a second operation of taking out a product of the second embodiment as same as illustrated in FIG. 3. As understood from FIG. 6, the same effect of the first embodiment is obtained even in the second embodiment.

### MODIFIED EXAMPLE

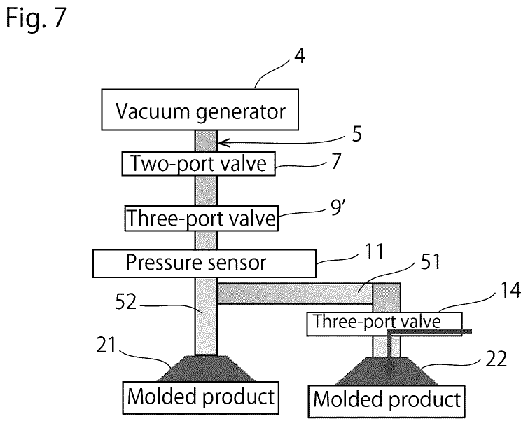

FIG. 7 is a diagram illustrating for explaining a modified example in case of providing a plurality of suction pads 21 and 22 at the take-out head for a plurality of products (a conveyance head). The modified example illustrated in FIG. 7 provides the plurality of suction pads 21 and 22, and a conduit line includes a plurality of branch conduit lines 51 and 52 respectively connected to the plurality of suction pads 21 and 22, and a common conduit line 5 connecting the plurality of branch conduit lines 51 and 52 to the vacuum generator 4. In addition, in the modified example, a pressure sensor 11 for detecting the pressure in the conduit line 5 during a suctioning operation is arranged at the suction pad side instead of the three-port valve 9′ side. Therefore, an additional three-port valve 14 opening the inside of the conduit line 51 to the atmosphere is provided in at least one branch conduit line 51 among the plurality of branch conduit lines 51 and 52. In this way, the suction pads 21 and 22 can be opened individually.

While the preferred embodiments of the invention have been described with a certain degree of particularity with reference to the drawings, obvious modifications and variations are possible in light of the above teachings. It is therefore to be understood that within the scope of the appended claims, the invention may be practiced other than as specifically described.

### INDUSTRIAL APPLICABILITY

According to the present invention, a part of negative pressure to be generated during a suctioning operation is stored in a negative pressure confining section, and both negative pressure stored in a negative pressure confining section and negative pressure generated by a vacuum generator are used in combination in a next conveying operation, thereby the energy consumption can be more reduced than those in the conventional technologies, since a part of negative pressure is reused without wasting negative pressure to be generated.

We claim:

1. A pneumatic circuit for conveying apparatus comprising:
one or more suction pads provided at a conveyance head to convey one or more conveyed products,
a conduit line arranged between the one or more suction pads and a vacuum generator, and
a control valve mechanism including two or more control valves arranged in the conduit line, supplying negative pressure generated by the vacuum generator to the one or more suction pads during a suctioning operation in which the one or more conveyed products are suctioned by the one or more suction pads, opening the inside of the one or more suction pads to the atmosphere and forming a negative pressure confining section in which the negative pressure is confined in a rear conduit section of the conduit line that is located closer to the vacuum generator than a front conduit section of the conduit line during a releasing operation in which the one or more conveyed products are released from the one or more suction pads, the two or more control valves being arranged to use both the negative pressure in the negative pressure confining section and the negative pressure generated by the vacuum generator when suctioning in a next conveying operation.

2. The pneumatic circuit for conveying apparatus according to claim 1, wherein:
the control valve mechanism includes a three-port valve provided in the front conduit section and a two-port valve provided in the rear conduit section,
the two-port valve is controlled to be in an open state during the suctioning operation and to be in a closed state during the releasing operation, and
the three-port valve is controlled to be in a first state in which the negative pressure generated by the vacuum generator is supplied to the one or more suction pads during the suctioning operation, and to be in a second state in which the supply of the negative pressure generated by the vacuum generator is blocked to form the negative pressure confining section between the three-port valve and the two-port valve and to open the inside of the one or more suction pads to the atmosphere during the releasing operation, and the three-port valve is controlled to change from the second state to the first state during the suctioning operation in the next conveying operation, so that the negative pressure in the negative pressure confining section and the negative pressure generated by the vacuum generator are used in combination.

3. The pneumatic circuit for conveying apparatus according to claim 1, wherein:
the control valve mechanism includes a first two-port valve and a second two-port valve provided at one end and the other end of the rear conduit section, respectively, and a third two-port valve provided in the front conduit section,
the first two-port valve and the second two-port valve are respectively in an opened state during the suctioning operation and both the first two-port valve and the second two-port valve are in a closed state during the releasing operation to form the negative pressure confining section between the first two-port valve and the second two-port valve, and both the first two-port valve and the second two-port valve are in an opened state during the suctioning operation in conveying operation to supply the negative pressure in the negative pressure confining section and negative pressure supplied from the vacuum generator to the one or more suction pads, and
the third two-port valve becomes a first state being able to supply the negative pressure generated by the vacuum generator to the one or more suction pads during the suctioning operation and becomes a second state to open the inside of the one or more suction pads to the atmosphere during the releasing operation, and is controlled so as to change from the second state to the first state before the suctioning operation in the next conveying operation is performed.

4. The pneumatic circuit for conveying apparatus, according to claim 2, wherein:
a plurality of the suction pads are provided on the conveyance head,
the conduit line has a plurality of branch conduits each connected to the plurality of the suction pads respectively and a common conduit connecting the plurality of branch conduits with the vacuum generator, and
an additional three-port valve is provided in at least one branch conduit among the plurality of branch conduits to open the inside of the at least one branch conduit to the atmosphere.

5. The pneumatic circuit for conveying apparatus, according to claim 3, wherein:
a plurality of the suction pads are provided on the conveyance head,
the conduit line has a plurality of branch conduits each connected to the plurality of the suction pads respectively and a common conduit connecting the plurality of branch conduits with the vacuum generator, and
an additional three-port valve is provided in at least one branch conduit among the plurality of branch conduits to open the inside of the at least one branch conduit to the atmosphere.

6. An apparatus for taking out a molded product including the pneumatic circuit for conveying apparatus, according to claim 1.

7. A method for controlling a pneumatic circuit for conveying apparatus comprising:
one or more suction pads provided at a conveyance head to convey one or more conveyed products,
a conduit line arranged between the one or more suction pads and a vacuum generator, and
a control valve mechanism including two or more control valves arranged in a path of the conduit, supplying negative pressure generated by the vacuum generator to the one or more suction pads during a suction operation in which the one or more conveyed products is suctioned by the one or more suction pads, and opening the inside of the one or more suction pads to the atmosphere during a releasing operation in which the one or more conveyed products are released from the one or more suction pads,
wherein the control valve mechanism controls the two or more control valves so as to form a negative pressure confining section in which the negative pressure is confined in a rear conduit section that is located closer to the vacuum generator than a front conduit section of the conduit line, and
the control valve mechanism further controls the two or more control valves so as to supply both the negative pressure in the negative pressure confining section and the negative pressure generated by the vacuum generator to the one or more suction pads during the suctioning operation in the next conveying operation.
